(19) United States
(12) Patent Application Publication
(10) Pub. No.: US 2002/0131517 A1
(43) Pub. Date: Sep. 19, 2002

(54) Digital transmission system having disparity dependent channel code words

(76) Inventors: Josephus Arnoldus Henricus Maria Kahlman, Eindhoven (NL); Arnold Karel Jansen Van Doorn, Eindhoven (NL); Jan Alexis Daniel Nesvadba, Eindhoven (NL)

Correspondence Address: U.S. Philips Corporation, 580 White Plains Road, Tarrytown, NY, 10591, US

(21) Appl. No.: 10/023,194

(22) Filed: Dec. 18, 2001

(30) Foreign Application Priority Data
Dec. 20, 2000 (EP) 00204646.4

(51) Int. Cl. H04L 25/34; H04L 25/49

(52) U.S. Cl. 375/286; 375/287; 375/288; 375/244

(57) ABSTRACT

A digital transmission system (1) comprises: a transmitter (2), a receiver (3), and a transmission channel (4) coupled there between. Both the transmitter (2) and the receiver (3) are provided with an encoder (5) and a decoder (6) respectively, wherein a multilevel input signal is coded such, that a DC-balanced digital channel code is transmitted. The coders (5, 6) are embodied to match levels of the DC-free multilevel input signal and code words of the DC-balanced digital channel code such, that disparities of the selected code words are symmetrically grouped around zero disparity. This results in a DC-free digital channel code signal having a limited transmission band width, which signal can be conveyed with minimal hardware over the usually AC-coupled transmission channels.

The present invention relates to a digital transmission system comprising: a transmitter, a receiver, and a transmission channel coupled to both the transmitter and the receiver, whereby the transmitter is provided with an encoder, wherein a multilevel input signal is encoded such, that an encoded DC-balanced digital channel code is transmitted to the receiver.

The present invention also relates to a transmitter and to a receiver for application in the digital transmission system, and to a digital code word set for application in the digital transmission system.

Such a digital transmission system is known from applicants EP-0 178 027. In the known transmission system digital information is transmitted through a transmission channel, which may consist of for instance magnetic, cable or optical means or free space. In such a transmission channel it is generally desirable to convey a DC-free digital signal having a frequency spectrum with a minimal low frequency content. Such a DC-free digital signal may comprise digital code words, which are selected from for instance bi-phase code words comprising as many ones as zeros. The disparity, which is the sum over the bit values of a code word of such a code word set, is zero for each bi-phase code word and consequently the transmitted signal is DC-free. Another possibility for such a DC-free digital signal is that only code words of a specific non zero disparity are selected. In that case a choice of code words having opposite disparities is made, which choice depends on the digital sum value (running sum) over preceding code words, in such a way that the absolute value of this digital sum value and therewith the DC content remains restricted. In the European patent above a still further possibility is elucidated, wherein by limiting a specific digital sum value, the second derivative of the energy spectrum of the code words is zero for zero frequency, which results in a reduction of the low-frequency content of the spectrum.

All these cases above have disadvantages in that the number of selectable code words is restricted and thus their efficiency is limited. In general also additional hardware is required for calculating the various digital sum values.

Therefore it is an object of the present invention to provide a digital transmission system only moderately requiring additional hardware in its transmitter and receiver, and providing a highly efficient DC-free code word set.

Thereto the digital transmission system according to the invention is characterized in that the encoder is embodied to match levels of the multilevel input signal and code words of the DC-balanced digital channel code such, that disparities of the selected code words are symmetrically grouped around zero disparity.

In a similar digital transmission system, whereby the receiver is provided with a decoder, wherein a received encoded DC-balanced digital channel code is decoded into a multilevel output signal, the invention is characterized in that the decoder is embodied to decode the received DC-balanced digital channel code words, whose disparities are symmetrically grouped around zero disparity.

It is an advantage of the above digital transmission systems according to the present invention that by such matching and symmetrically grouping of disparities of the selected code words around zero disparity, the amplitude probability density function of the encoded DC balanced channel code is also symmetrically around zero. Starting from a DC-free input signal this results in an average DC-free and low-frequency channel code signal. A consequence for the DC-free channel code signal is, that its bandwidth is limited, and that therefore synchronization by means of for example a phase locked loop can be effected appropriately. Advantageously code words having the same disparity can be interchanged, which increases the flexibility of the encoding structure of the code word set. Because almost all code words can be used, without any extra coding bits being needed, the encoding takes place virtually without any loss and is very efficient, while a high bit rate is achievable.

An embodiment of the digital transmission system according to the invention is characterized in that the encoder and/or decoder comprise(s) a look-up table containing data about the levels of the multilevel input signal corresponding to code words of the DC-balanced digital channel code.

Advantageously in this embodiment of the digital transmission system according to the invention only a simple look-up table suffices for conversion from the multilevel input signal to the assigned code words having the zero balanced disparities.

A further embodiment of the digital transmission system according to the invention is characterized in that the data in the look-up table shows a monotonous relation between the consecutive levels of the multilevel input signal and the consecutive disparities of the corresponding selected code words.

Such an embodiment results in a simple look-up table having a reduced size.

A still further embodiment of the digital transmission system according to the invention providing a speedy look-up, is characterized in that the data in the look-up table shows a monotonous relation between the consecutive increasing or decreasing respective levels of the multilevel input signal and the consecutive increasing or decreasing respective disparities of the corresponding selected code words.

Advantageously, not necessitating additional word synchronization bits, a following embodiment of the digital transmission system according to the invention is characterized in that one or more of the not selected code words is used as a synchronization word.

At present the digital transmission system, transmitter, receiver and code word set all according to the invention will be elucidated further together with their additional advantages, while reference is being made to the appended drawing, wherein similar components are being referred to by means of the same reference numerals.

In the drawing:

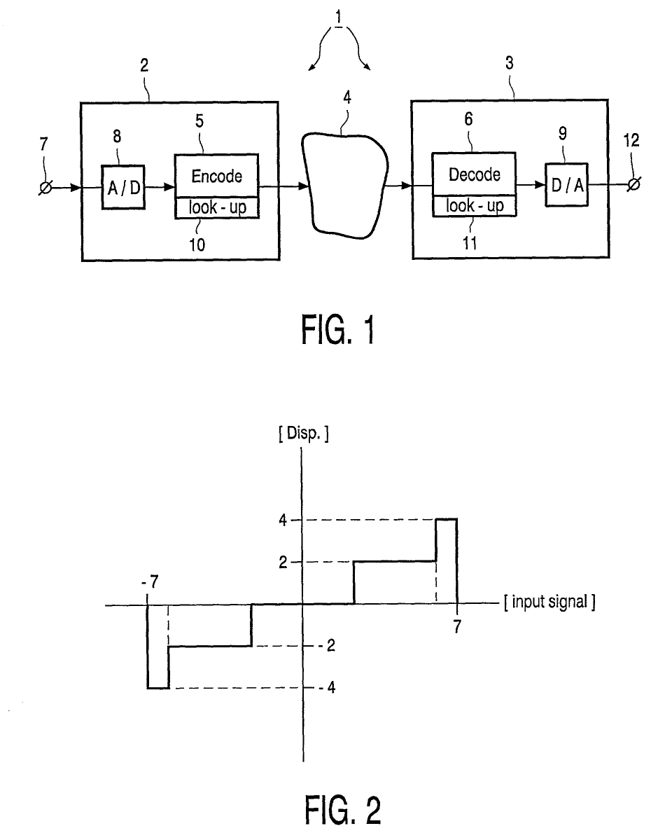

FIG. 1 shows a basic scheme of an implementation of the digital transmission system according to the present invention, and

FIG. 2 shows a graph of a monotonous course of the disparity as a function of the levels of a multilevel input signal for a possible implementation of the digital transmission system according to the invention.

FIG. 1 shows a digital transmission system 1 comprising: a transmitter 2, a receiver 3, and a transmission channel 4 coupled to both the transmitter 2 and the receiver 3. The transmitter 2 is provided with an encoder 5, and similarly the receiver 2 is provided with a decoder 6. A signal on input terminal 7 of the transmitter 2 is a multilevel input signal, such that its amplitude may take a number of discrete values. The number may for example be 2, 4, 8, 16, . . . , 1024, etcetera. Hereafter examples will be given of implementations, where this number is 16 and 1024.

The multilevel input signal is converted into a digital signal by means of an analog to digital converter 8 and then encoded in the encoder 5, which may at wish be included in the converter 8. The encoded output signal comprises code words, which are devised to comprise a minimal DC content when properly selected and transmitted through the transmission channel 4, as will be explained later on. The transmission channel 4 may comprise cable means, wire means, optical means, such as from glass fiber, free space or a combination thereof, and is therefore schematically shown as a cloud. The system 1 may for example be implemented in a CATV return signal path, wherein amplitude modulated RF carriers are transmitted over a channel having a bandwidth ranging from 3 MHz to 42 MHz (in the USA) or to 65 MHz (in Europe). These channels are usually AC coupled and therefore the transmitted encoded output bitstream, which is received by the receiver 3 has to be DC-free, and has to have a moderate low-frequency content. The receiver 3 is provided with the decoder 6, which is coupled to the channel 4 in order to decode the received code words of the transmitted signal, whereafter it may be fed to a digital to analog converter 9 for providing an analog output signal to a receiver output terminal 12.

The encoder 5, as well as the decoder 6 will in the case as shown be embodied to match amplitude levels of the multilevel input signal and code words of the digital channel code set words. This is usually done by means of respective look-up tables 10 and 11, in the encoder 5 and decoder 6 respectively, which contain data in the form of the amplitude levels and the code words above. The matching takes place such, that disparities of the selected code words are symmetrically grouped around zero disparity resulting in a DC-balanced digital channel code. A possible implementation thereof is presented in table I hereunder, which shows in the first column the amplitude levels of the input signal on terminal 7, in the second column terminal code words of the devised code which are each assigned to a particular amplitude level, and in the third column the respective disparities of the code words.

TABLE I

| Level input signal | Four bit code word | Code word disparity |
|---|---|---|
| +7 | 1111 | +4 |
| +6 | 1110 | +2 |
| +5 | 1101 | +2 |
| +4 | 1011 | +2 |
| +3 | 0111 | +2 |
| +2 | 0110 | 0 |
| +1 | 1100 | 0 |
| 0 | 1010 | 0 |
| −1 | 0011 | 0 |
| −2 | 1001 | 0 |
| −3 | 1000 | −2 |
| −4 | 0100 | −2 |
| −5 | 0010 | −2 |
| −6 | 0001 | −2 |
| −7 | 0000 | −4 |

The code words are each assigned to respective levels of the multilevel input signal, whereby in this particular case as shown there exists a monotonous -not decreasing-relation between the consecutive levels of the multilevel input signal and the disparities of the corresponding selected code words. There are five different disparity classes i.e. +4, +2, 0, −2, and −4. The disparity of the code words as a function of the amplitude level of the input signal is shown in FIG. 2 and it clearly shows the monotony for this case, as well as symmetry of the disparity around zero disparity, that is rotation over 180 degrees of the branch of the graph above or below zero, around zero yields the other branch. At wish for providing flexibility of the concept concerned code words having the same disparity can be interchanged and assigned to neighboring amplitude levels. For example the code words assigned to the levels +3, +4, +5, and +6, all having disparity +2, can be interchanged, which has no effect on the disparity distribution around zero disparity. Of course other combinations and assignments of code words to levels of the input signal are possible, where the disparities are all symmetrically grouped around zero disparity. The code word set as shown here has four bits. From the 16 possible code words the alternating code word 0101 can advantageously be used for synchronization purposes.

Table II hereunder shows the main structure of a 10 bit code word set for a 1024 level input signal. In this case the input signal has 1024 amplitude levels, which leads to 11 different disparity classes, each having a number of code words which is placed between brackets. For example there exist 10 possible combinations of ‘0’ and ‘1’ bits in a code word having disparity ‘8’. The code word 1111111110 being one of the 10 possible combinations.

By displacing the ‘0’ through the code word to the beginning thereof the other possible combinations can be found instantly.

TABLE II

| Level input signal | Code word disparity |
|---|---|
| 511 | 10 (1) |
| 510 . . . 501 | 8 (10) |
| 500 . . . 456 | 6 (45) |
| 455 . . . 336 | 4 (120) |
| 335 . . . 126 | 2 (210) |
| 125 . . . −126 | 0 (252) |
| −127 . . . −336 | −2 (210) |
| −337 . . . −456 | −4 (120) |
| −457 . . . −501 | −6 (45) |
| −502 . . . −511 | −8 (10) |
| −512 | −10 (1) |

For finding a suitable synchronization word properties of the analog input signal can be used. For example if the input level combination −504, −512, −511 does not arise then the sync word: 0010000000 0000000000 0000000001 would be suitable.

In general the allocation of code words to the respective amplitude levels of a DC-free input signal is such that if the disparity of the code words are symmetrically grouped around zero, then the output signal is DC-free too. The same is true if the amplitude probability density function of the input signal amplitude is symmetric around zero.

Whilst the above has been described with reference to essentially preferred embodiments and best possible modes it will be understood that these embodiments are by no means to be construed as limiting examples of the systems concerned, because various modifications, features and combination of features falling within the scope of the appended claims are now within reach of the skilled person.

1. A digital transmission system (1) comprising: a transmitter (2), a receiver (3), and a transmission channel (4) coupled to both the transmitter (2) and the receiver (3), whereby the transmitter (2) is provided with an encoder (5) wherein a multilevel input signal is encoded such, that an encoded DC-balanced digital channel code is transmitted to the receiver (3), characterized in that the encoder (5) is embodied to match levels of the multilevel input signal and code words of the DC-balanced digital channel code such, that disparities of the selected code words are symmetrically grouped around zero disparity.

2. A digital transmission system (1) comprising: a transmitter (2), a receiver (3), and a transmission channel (4) coupled to both the transmitter (2) and the receiver (3), whereby the receiver (3) is provided with a decoder (6), wherein a received encoded DC-balanced digital channel code is decoded into a multilevel output signal, characterized in that the decoder (6) is embodied to decode the received DC-balanced digital channel code words, whose disparities are symmetrically grouped around zero disparity.

3. The digital transmission system (1) according to claim 1 or 2, characterized in that the encoder (5) and/or decoder (6) comprise(s) a look-up table (10; 11) containing data about the levels of the multilevel input signal corresponding to code words of the DC-balanced digital channel code.

4. The digital transmission system (1) according to claim 3, characterized in that the data in the look-up table (10; 11) shows a monotonous relation between the consecutive levels of the multilevel input signal and the consecutive disparities of the corresponding selected code words.

5. The digital transmission system (1) according to claim 4, characterized in that the data in the look-up table (10; 11) shows a monotonous relation between the consecutive increasing or decreasing respective levels of the multilevel input signal and the consecutive increasing or decreasing respective disparities of the corresponding selected code words.

6. The digital transmission system (1) according to one of the claims 1-5, characterized in that one or more of the not selected code words is used as a synchronization word.

7. A transmitter (2) suited for application in a digital transmission system (1) according to one of the claims 1-6, the digital transmission system (1) comprising: a transmitter (2), a receiver (3), and a transmission channel (4) coupled to both the transmitter (2) and the receiver (3), whereby the transmitter (2) is provided with an encoder (5) wherein a multilevel input signal is encoded such, that an encoded DC-balanced digital channel code is transmitted to the receiver (3), characterized in that the encoder (5) is embodied to match levels of the multilevel input signal to code words of the DC-balanced digital channel code such, that disparities of the selected code words are symmetrically grouped around zero disparity.

8. A receiver (3) suited for application in a digital transmission system (1) according to one of the claims 1-6, the digital transmission system (1) comprising: a transmitter (2), a receiver (3), and a transmission channel (4) coupled to both the transmitter (2) and the receiver (3), whereby the receiver (3) is provided with a decoder (6), wherein a received encoded DC-balanced digital channel code is a decoded into a multilevel output signal, characterized in that the decoder (6) is embodied to decode the received DC-balanced digital channel code words, whose disparities are symmetrically grouped around zero disparity.

9. A digital code word set for application in the digital transmission system (1) according to one of the claims 1-6, comprising code words having disparities, characterized in that the disparities of the code words are symmetrically grouped around zero disparity.

10. The digital code word set according to claim 9, characterized in that the disparities of the code words are grouped in not decreasing disparity.
